(19) United States
(12) Patent Application Publication
(10) Pub. No.: US 2020/0311741 A1
(43) Pub. Date: Oct. 1, 2020

(54) METHODS AND SYSTEMS FOR VALIDATING ORDER REQUEST

(71) Applicants: Mark Dorchen, Farmington Hills, MI (US); David Christy, Rochester Hills, MI (US)

(72) Inventors: Mark Dorchen, Farmington Hills, MI (US); David Christy, Rochester Hills, MI (US)

(21) Appl. No.: 16/774,317

(22) Filed: Jan. 28, 2020

Related U.S. Application Data
(60) Provisional application No. 62/824,833, filed on Mar. 27, 2019.

(51) Int. Cl. G06Q 30/00; G06F 40/174; G06K 9/00

(52) U.S. Cl. CPC G06Q 30/018; G06K 9/00664; G06F 40/174

(57) ABSTRACT

A methodology and structure for verifying the work being performed at a work site that is remote from the inspection company, e.g., construction or repairs. A server can receive a request for information and generate a unique electronic form with a plurality of graphical user interfaces (GUI) based on the category of work. The form can be accessed by a user, who may not be a professional inspector, and walk the user through the required information for an inspection by stepping through the GUIs. This will reduce the need to schedule a meeting between a professional inspector and the user (home owner). The inspection server can validate the information submitted by the user device using location coordinates of the images or the user device.

### CROSS REFERENCE TO RELATED APPLICATION

This disclosure claims benefit of U.S. Provisional patent Application No. 62/824,833, titled “Methods and Systems for Initiating a Loss Draft Insurance Order Request”, filed on 27 Mar. 2019, which is hereby incorporated by reference in its entirety.

### TECHNICAL FIELD

This disclosure relates to methods and systems to for validating an order request and for generating repair affidavits with supporting documentation.

### BACKGROUND

Construction projects typically are financed by third parties that require milestone payments to the construction company. The milestones can be set forth in the construction contract. The milestones must be documented for payments to be released or verify that the timeline of the construction project is being met. Such verification may be cumbersome for additions or repairs to a building. It can be difficult to schedule a mutually convenient meeting time for an inspector to document progress at the building location.

### SUMMARY

This disclosure relates generally to memory systems and methods for verifying the work being performed at a work site that is remote from the inspection company, e.g., construction or repairs. This will reduce the need to schedule a meeting between a professional inspector and the user (home owner).

It is one aspect of the present disclosure to provide a method comprising a first step of receiving an electronic form including an image and work progress data wherein the validation data includes location coordinates and at least one of: device identification, end user signature, requested data relating to status of work progress, work completion indication, or combinations thereof. The method also includes a step of comparing the location coordinates to stored property location to verify the image and work progress data in the form. In response to the location coordinates matching stored location coordinates, the method proceeds with a step of approving the image at the location of interest. In response to the location coordinates not matching the stored location coordinates, the method proceeds with a step of requesting a user to upload new images.

In another aspect of the present disclosure to provide a loss draft system. The loss draft system comprise an inspection server to generate an electronic inspection form that requests image and work progress data. The validation data includes location coordinates and at least one of: device identification, end user signature, requested data relating to status of work progress, work completion indication, or combinations thereof. The inspection server stores location coordinates of the work site. A user device is in remote communication with the inspection server and configured to engage the electronic form to provide images and location coordinates. The inspection server compares the location coordinates from the user device with the stored work site coordinates to verify the image and work progress data in the electronic form, with the location coordinates matching stored work site coordinates, approving the image as being of the work site, and with the location coordinates not matching the stored work site coordinates, the inspection server requests a new image from the user device.

In an aspect of the present disclosure, methods and systems for imitating a loss draft insurance order request to verify, to document and to provide a legal affidavit from the homeowner to the insurance lien holder that the insurance loss in question has been provided in good faith and has been completed satisfactorily per the scope of work provided to the insurance lien holder.

These and other aspects of the present disclosure are disclosed in the following detailed description of the embodiments, the appended claims, and the accompanying figures.

### BRIEF DESCRIPTION OF THE DRAWINGS

The accompanying drawings, which are incorporated in and constitute a part of this specification illustrate various aspects of the invention and together with the description, serve to explain its principles. Wherever convenient, the same reference numbers will be used throughout the drawings to refer to the same or like elements.

FIG. 1 shows a schematic view for validating a repair order with supporting documentation according to an example embodiment.

FIG. 2 shows a schematic view for validating a repair order with supporting documentation according to an example embodiment.

FIG. 3A shows a flow chart of a method according to an aspect of the present disclosure.

FIG. 3B shows a flow chart of a method according to an aspect of the present disclosure.

FIG. 3C shows a flow chart of a method according to an aspect of the present disclosure.

FIG. 4 shows a system according to an aspect of the present disclosure.

FIG. 5 shows a block diagram illustrating an exemplary software architecture according to an example embodiment.

FIG. 6 shows a block diagram illustrating an exemplary machine according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Among other things, embodiments of the present disclosure improve the functionality of analyzing and validating for construction or repair to structures using the described methods and systems. An aspect allows for the validation of status report, e.g., images, without the requirement of sending a trained inspector to location. In an aspect, the homeowner or manager may be validated in the system and upload images and status. In an aspect, the images are also validated. The report and images can be packaged by an inspection computer into a package to provide to the requesting party. The present system may save time and process the images related to work in progress at faster rate than prior methodology.

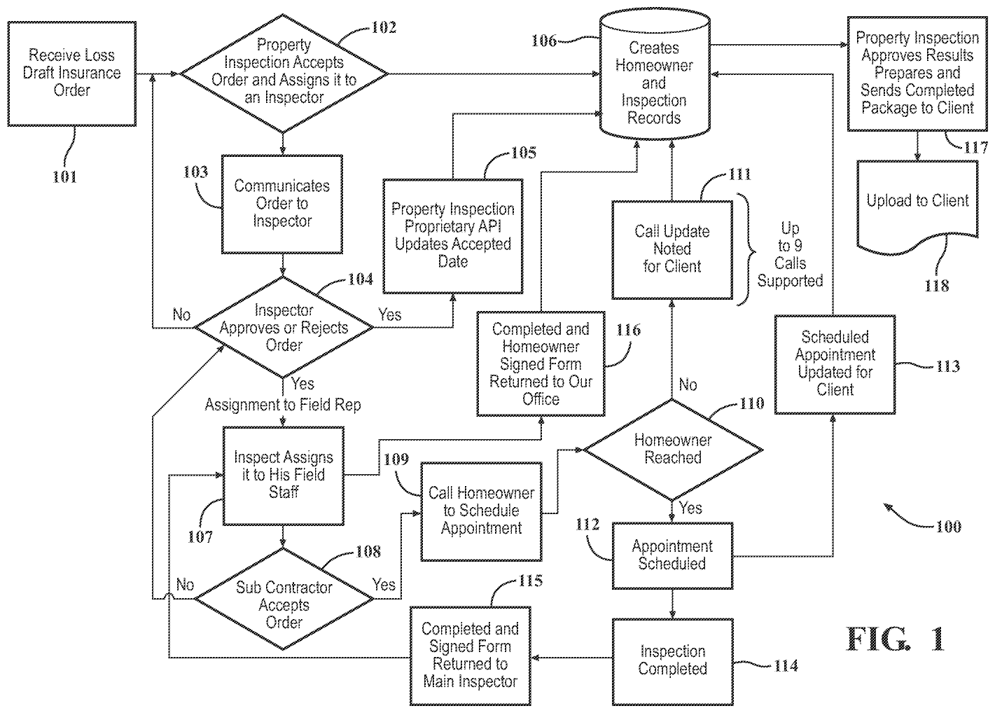

FIG. 1 generally illustrates a scheme 100 for validating a construction or rehabilitation of a structure. The scheme 100 uses automated processes and systems to process request for substantiation of status of work at a construction or repair. The request of documentation is received and assigned to an inspector, who arranges for an in-person inspection to document the status. The inspector must make contact with the person in charge of the property, e.g., a manager or home owner, to schedule a mutually agreeable time to meet at the structure for an in-person inspection. The inspector and not the property owner loads information to document the status into a server.

At 101, a loss draft insurance order is received by the property inspection server. The property inspection server is an machine at a company, a property inspection company, which can review multiple properties for multiple third parties, such as banks, insurance companies or other interested parties in the construction or repair of a structure on real estate. In an example, the draft insurance loss order is received via an electronic communication and includes identifying information of the property, e.g., address, owner, manager and other pertinent information. In an example, the loss draft insurance order is a request for the status of repair of the structure. The status may be required due to a contractual obligation. The status may be required before a payment is released to a contractor performing the repair or construction.

At 102, the property inspection company accepts the order and assigns it to an inspector.

At 103, the order is communicated to an inspector. The communication can be an electronic communication, which can include the identification of the property and the areas and type of repairs or construction activity.

At 104, the inspector accepts the order or rejects the order. If the order is rejected, the process returns to block 102. If the inspector accepts the offer, the process proceeds to two blocks in parallel.

At 105, the property inspection company using a computer communication, e.g., an API, updates the date of acceptance and sets a completion date.

At 106, the property inspection company creates both a property owner record and an inspection record. The property owner record and the inspection record can be linked together.

At 107 and in parallel with blocks 105-106, the inspector assigns the inspection activity to the field staff member who will conduct the inspection.

At 108, if the field staff member refuses the assignment, the method returns to block 107. If the field staff member accepts the order, then the flow continues to block 109.

At 109, the field staff member contacts the homeowner or the site manager. This may be a time consuming task as the records of the contact information for the homeowner may not be current.

At 110, it is determined if the homeowner is contacted by the field staff member. If not, then the contact information is stored at 111 and uploaded to the records in the database at 106. If the homeowner is contacted, then at 112 the appointment is scheduled.

At 113, the scheduled appointment is updated to the records at 106.

At 114, the inspection occurs. This requires the field staff member to travel to the home or structure on the real property and be allowed access to the areas of interest. The field staff member documents the status of the repair or construction by noting the address and visually inspecting the appropriate area. The field staff member has the property owner or manager sign the inspection report.

At 115, the field staff member completes an inspection form including the visual inspection of the areas of interest and turns the form to the inspector at block 107.

At block 107, the inspector reviews the form.

At 116, the inspector ensures the form is complete, includes signature of the property owner or manager and thereafter sends the form to the records stored in the database at block 106.

At 117, the property inspection company reviews the resulting report and prepares a completed package for the client who requested the inspection or issued the loss draft insurance order. The completed package is reviewed for quality control.

At 118, the completed report is transmitted to the client.

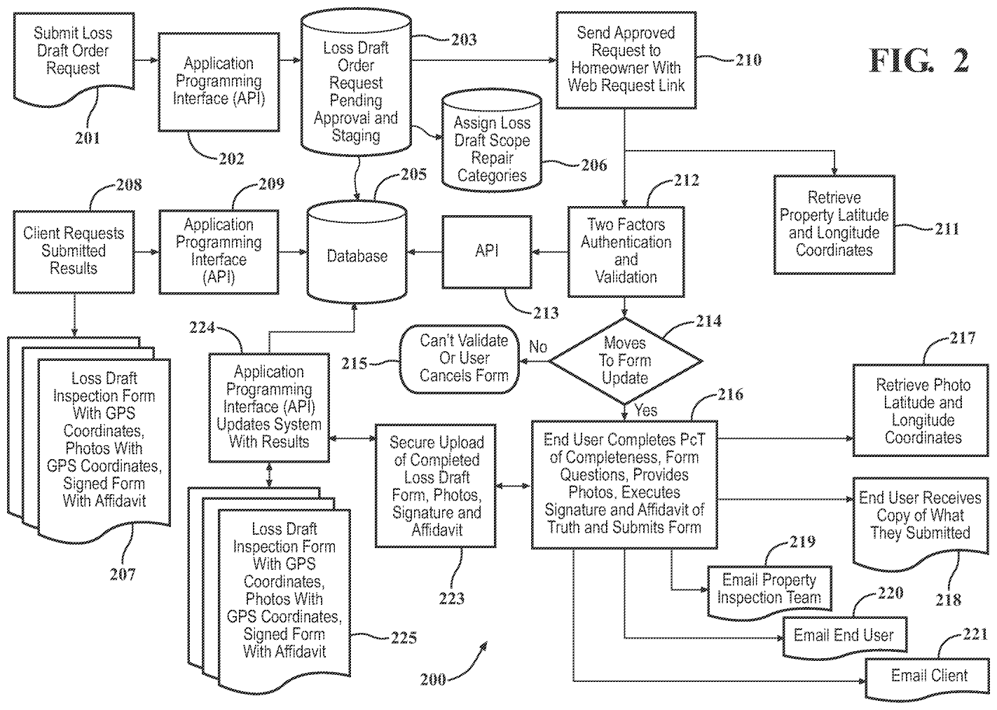

FIG. 2 generally illustrates a scheme 200 for validating a construction or rehabilitation of a structure. The scheme 200 uses automated process and systems to eliminate the need for an inspector to drive out to the structure and conduct an in-person inspection of the structure and the work completed to date. This is in contrast to conventional methods which require an intermediary to assign an inspector at the request of a payor, such as a bank, lien holder or an insurance company. The inspector must make contact with the person in charge of the property, e.g., a manager or home owner, to schedule a mutually agreeable time to meet at the structure for an in-person inspection.

At 201, a loss draft insurance order is received by the property inspection server which is interfaced through the application programming interface 202. The application programming interface 202 provides an interface to the property inspection server. The server is a machine at a company, a property inspection company, which can review multiple property actions for multiple third parties, such as banks, insurance companies or other interested parties in the construction or repair of a structure on real estate. In an example, the draft insurance loss order is received via an electronic communication and includes identifying information of the property, e.g., address, owner, manager and other pertinent information. In an example, the loss draft insurance order is a request for the status of repair of the structure. The status may be required due to a contractual obligation. The status may be required before a payment is released to a contractor performing the repair or construction.

At 203, the loss draft order request is stored pending approval and staging. Staging is performed to gather the in types of information needed to validate the status of the construction. The approval is performed to approve the request for processing the request for validation information.

At 205, a database is provided to store all of the data relating to the loss draft order, the inspection, the categories related to the work and the documentation returned from the homeowner or non-professional inspector.

At 206, the categories of repair are assigned to the loss draft order. The categories provide the types and quantity of documentation needed for the validation of the status of the work completed. This can be based on the summary of loss or the work required at the property.

At 210, the property inspection server sends an approved request to the homeowner or property manager, i.e., the user, with a web link. The web link can take the user to a predetermined form that requests certain documentation from the user.

At 211, the property inspection server downloads the location of the property in need of inspection. In an example embodiment, the server retrieves the geolocation including longitude and the latitude of the property.

At 212 the system uses two factor authentication in order to authenticate the user. The user will be stored in the database 205 with a second form of contact to provide a second authentication code or the like. The second form of contact can be a text message, email or phone call. This second factor is entered into the form at the web link.

At 213, the API provides an interface between the user's device and the property inspection server's database 205.

At 214, the form is updated and provides the form to the user if the user is authenticated.

At 215, the process flow ends if the user is not authenticated and validated.

At 216, the user enters information into the form being displayed on their device as fed to the device by the property inspection server. The form is set by the category of the work being done and the requirements of the requestor of the status of the work to date. The form can include a field for the user to estimate the completeness status of the work, e.g., zero % to 100%, or not begun to complete. The completeness field can be a number scale or a word scale. The word scale can be based on the category. For example, demolition started, demolition complete, framing started, framing complete, framing inspected, electrical started, electrical complete, electrical inspected, plumbing started, plumbing complete, plumbing inspected, wall started, wall taped, wall painted, fixtures installed, wall painted, etc. These word description fields in the form may be easier for a user, who may not be experienced in construction or repair to describe the work done to date. The property inspection server can turn these word field entries into a quantifiable amount of work done to date. The user will also be required to upload images of the work location. The user can upload images on their electronic device to the appropriate fields on the form. The form can also require the user to execute an affidavit that the information being submitted through the user device to the property inspection server is true and accurate. The user can review all of the information and submit the form. The form may have a single action for the user on a single graphical user interface being displayed to the user. When the user completes the entry on the single graphical user interface, the property inspection server will feed a new graphical user interface to the user device.

At 217, the images uploaded by the user will be checked for the location of the image, e.g., from the metadata in the image itself or the location of the user's imaging device that is uploading the images. The longitude and the latitude of the image is retrieved.

At 218, the user is provided a copy of what was submitted. This can be sent as an entire package through an email. The user can be provided with a secure link where the submission can be downloaded by the user.

At 219, the property inspection server notifies the appropriate devices of the team at the property inspection company that a submission related to a request has been received.

At 220, the property inspection server notifies the appropriate devices of the user that a submission related to a request has been received by the property inspection server.

At 221, the property inspection server notifies the appropriate devices of the client who submitted the request that a submission related to a request has been received by the property inspection server.

At 223, a secure download of the graphical user interfaces of the form to the user device and an upload of the entries entered into the form is performed between the user device and the property inspection server.

At 224, the API provides an interface between the database and the user device. The API generates and receives information of the inspection form as needed for a particular project at 225. The inspection form will require location coordinates, images with location coordinates and an affidavit section.

At 208, the results of the inspection are provided to the client who submitted the request. At 209, the API interacts with the database to provide the client with the form at 207.

An embodiment of the present scheme has the user, e.g., the homeowner, log into a secure website that provides the form with fields to receive information. The fields in the form are determined by the scope of work to be inspected at the location. Some field are required based on the scope of work, which is a category. For example, if there is a minor kitchen fire being repaired (e.g., a kitchen fire category), the user must provide pictures of the kitchen to the website. If the category is a major kitchen fire, then the user must provide pictures of the kitchen and any other areas of the home that may have smoke damage. The user must also provide an estimate of the amount of work completed to date in other field on the web page.

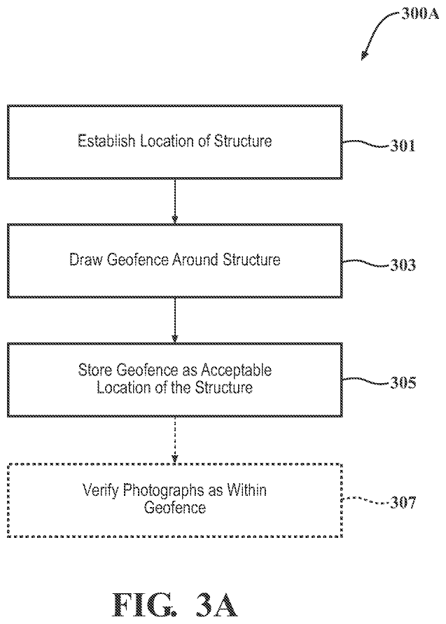

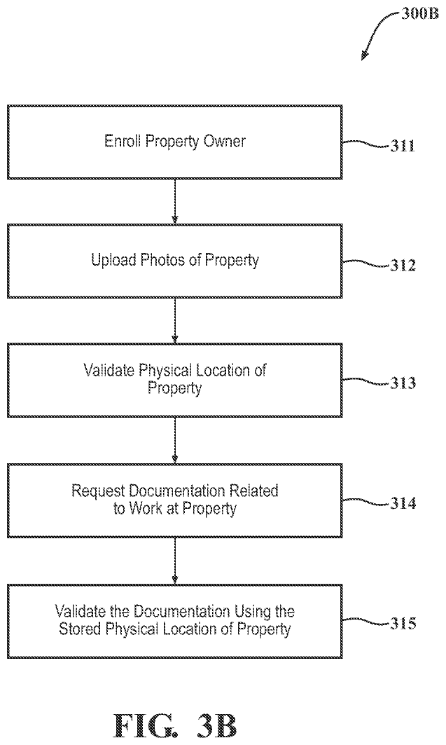

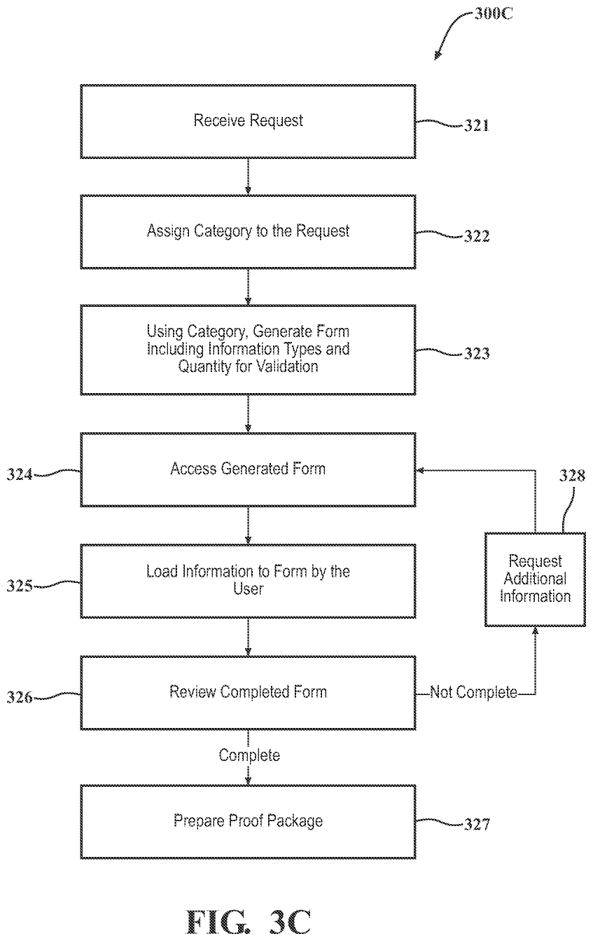

FIG. 3A generally illustrates a method 300A to establish the location of a structure of interest at which a work project is being performed. At 301, the location of the structure is established. The location can be established by an API entering an address into a map data base or mapping application, which can return the longitude and latitude for the address. The location of the structure can also be established by the user, using a user-related device, logging into the secure the web site, e.g., a graphical user interface as part of a form, and providing the longitude and the latitude using a satellite navigation system, e.g., GPS, Galileo, GLONASS or the like.

At 303, a geofence is drawn around the location coordinates. The geofence defines the range about the coordinates established ion step 301. This can account for inaccuracies of the user device used to establish the initial location. Moreover, the user device may not be located at the exact location of the work being performed. In an example embodiment, the third-party paying for the work or authorizing the work can set the distance for the geofence.

At 305, the geofence is stored in the database and used by the API as an acceptable location of the structure at which the work is being performed. The acceptable location is used to validate the images being submitted to verify the work being performed.

At 307, the optional step f using the geofence to verify the images submitted as supporting the work being performed.

FIG. 3B illustrates a method 300B for a user to interact with the inspection system. The user, who in some embodiments of the present disclosure, is not a professional inspector. Accordingly, the user must enroll in the system to use the methodology to provide documentation of the progress of the work, which can be construction or repair.

At 311, the user is enrolled. The user can be a property owner. The user, using a user device, can access the system though an electronic invitation, e.g., a secure link or image code that directs the user device to a secure website operated by the inspection company. In an example embodiment, the enrollment uses two-factor authentication. The user's information can be sent to the inspection company from the interested third-party, which is requiring the status of the construction or repair.

At 312, the user can use their own device to upload images of the repair work. In an example embodiment, the user uploads images of the structure with identifying information in the image along with location coordinates. The image can be an image of the structure with the street address in the image, e.g., the exterior of the home with the house number either on the home or on the mailbox with the home in the image.

At 313, the inspection company using its devices and servers, validates the physical location, e.g., coordinates, of the user's structure using the images and the supplied or derived coordinates. In an example embodiment, the structure's coordinates can be derived from the address and table of address to coordinates or by entering the address into a mapping application.

At 314, the documentation related to the work at the property can be requested. The documentation can include images and other entries into the form provided to the use using a graphical user interface, which can be formed by on the category of the work being performed. The documentation can be uploaded by the user, e.g., property owner or manager, though a graphical user interface.

At 315, the documentation is validated using the location coordinates supplied with the uploaded documentation compared to the stored physical location of the property.

FIG. 3C illustrates a method 300C for a verifying the work completed at a location.

At 321, a request to verify the status of the work at a specific physical location is received. The request can be from a device or system associated with a third-party, e.g., a mortgage company, an insurance company, a bank, a lien holder or the like The request can include the location of the property and the type of work being performed.

At 322, a category is assigned to the request based on the type of work to be performed. A roof replacement will be categorized differently than repairs due to a kitchen fire. A total home replacement will be categorized differently than the kitchen fire. Each category will be associated with different requirements for information related to the type of work.

At 323, the inspection server uses the category to generate a form that includes the information types and quantity for validation of the work progress. Each category will have its own set of data entry blocks in the form. The form can be a series of graphical user interfaces that each request the validation information for the category. The forms can be generated in real-time based on the category with the data entry being associated with the category in a table stored in the database.

At 324, the generated form in the inspection server is accessed by a user device. The user device may need to be validated using two factor authentication. In an example embodiment, the user device provides it location coordinates, e.g., using a satellite navigation system, to validate the access. The user device may need to be within a geofence at the property location to access the form.

At 325, the user device loads information requested by the form into the form data entry fields. The data entry fields displayed on the user device may request images, estimates or work completed in quantitative form or by written description.

At 326, the inspection company, remote from the location of the property, can review the completed form, e.g., the images uploaded, to insure that the images are of the worksite. The inspection company can also verify the quantified amount or work completed by reviewing he images. The inspection company servers can also verify the location of the images using the stored location of the physical property.

At 327, if the information related to the form and the property of complete relative to the request, then a proof package is prepared and submitted to the third party.

At 328, if the information is not adequate to verify the work completed at the location, then the inspection company server will request additional information from the user and return to the step 324 and provide access to a form to the user device. The accessed form, when the process returns, can include indicators to what information is missing or in need of clarification.

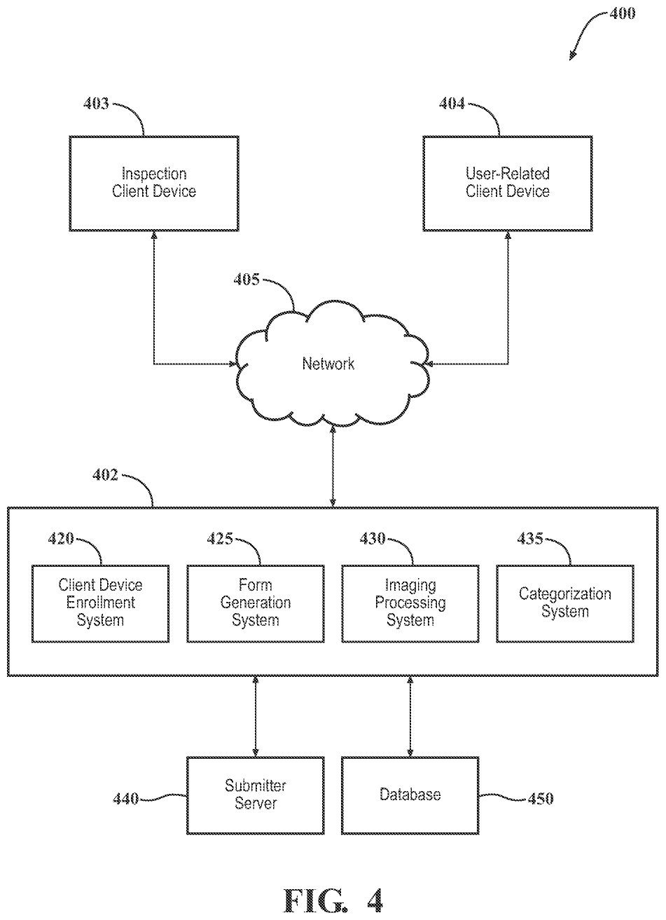

FIG. 4 generally illustrates a block diagram of a system 400 according to various exemplary embodiments. The system 400 can be a reporting system that includes an inspection service server system 402, an inspection system client device 403, and a user-related client device 404, which are communicatively coupled over an electronic communication network 405 (e.g., Internet, telephony network, electronic communication network or the like). The inspection system client device 403 and the user-related client device 404 can connect through the network by one or more of an audio call (e.g., VoIP, Public Switched Telephone Network, cellular communication network, etc.) or via electronic messages (e.g., online chat, instant messaging, text messaging, email, and the like). While FIG. 1 illustrates a single inspection system client device 403 and a single user-related client device 404, it is understood that a plurality of devices 403, 404 can be included in the system 400 in other embodiments. As used herein, the term “client device” may refer to any machine that interfaces to a communications network (such as network 405) to obtain resources from one or more systems or other client devices. A client device may be, but is not limited to, a mobile phone, desktop computer, laptop, portable digital assistants (PDAs), smart phones, a wearable device (e.g., a smart watch), tablets, ultrabooks, netbooks, laptops, multi-processor systems, microprocessor-based or programmable consumer electronics, game consoles, set-top boxes, communication-enabled cameras, or any other communication device that a user may use to access a network. The user-related client device 404 can include an imager, e.g., a camera, on a mobile electronic device, a telephone, or other mobile device.

The network 405 may include, or operate in conjunction with, an ad hoc network, an intranet, an extranet, a virtual private network (VPN), a local area network (LAN), a wireless network, a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

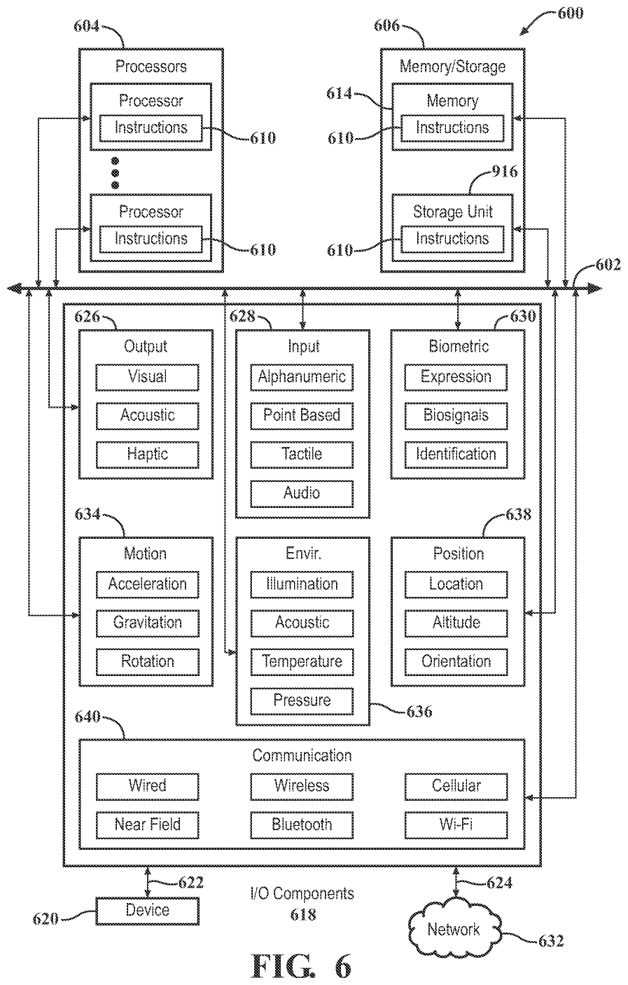

In the example shown in FIG. 4, a user using the user-related client device 404 can establish a communication session with the inspection service server 402 or an inspection client device 403. The user-related client device 404 is sued by a user, e.g., a non-professional inspector to provide status of construction or repair at a structure. The user device can be a device described herein, e.g., the device 600 described with reference to FIG. 6. The user-related client device 404 can interact with the form generated by the inspection service server 402 and enter information into the form related to the project, e.g., images with location coordinates.

The inspection service server system 402 includes a client device enrollment system 420, a form generation system 425, an image processing system 430, and a categorization system 435. In an example embodiment, the inspection service server system 402 can include components that can implement the schemes described with regard to FIGS. 1 and 2.

The client device enrollment system 420 can be used to enroll the user-client device 404 with the inspection service server system 402. The client device enrollment system 420 can enter a user-related device that is associated with a homeowner or property manager into the system 402. The enrollment allows the system 402 to send communications to and from the user-client device 404, e.g., the images related to the work project at the property.

The form generation system 425 operates to generate a graphical user interface that can be displayed on the client devices 403, 404. The graphical user interface can be launched when the user-related client device 404 is authenticated and validated as being the user's device, with the user being in charge of the property at which the work is being performed. The form generation system 425 can request images and work completed information from device 404. The device 404 can also provide the location data through the form from the form generation system 425.

The image processing system 430 can receive images through the network 405 from the user-related client device 404. These images can be those requested by the form from the form generation system 425. The image processing system 430 can operate to read the data associated with the image to extract the location data. The location data can be latitude and longitude data in the image meta-data. In another example embodiment, the image processing system 430 can associate location coordinates from the user-related client device 404 to a given image loaded to the form from the user-related device 404. That is, the device 404 sends GPS coordinates along with the image data.

The image processing system 430 can also operate to compare prior images of the work at the same location. The system 430 can highlight a difference, if any, in the successive images with prior images. The system 430 can show that work has been done at the location.

The image processing system 430 can also operate to imprint the location coordinates on the images themselves to provide a location identifier directly on the image.

The categorization system 435 operates to categorize the work being done and generates the required data for the form to be provided to the user, e.g., the user-related client device 404.

A submitter server 440 communicates with the inspection service server 402 to provide a request for an inspection, e.g., a loss draft insurance order or a build status request. The submitter server can be a machine at a third-party payor that is paying for the build or repair of the property. Examples of a third party payor include a mortgage company, an insurance company or the like. The third party payor may have the legal right to the status of the repair or build at the property.

A database 450 is provided that can store the categories of work, the data entry fields for each category, the requirements for the requestor (e.g., the operator of the submitter server 440), user information, and the location of the properties that will require inspection. The database can be provided with new or updated data related to the property of verification of the work to date using an API. The API can also provide an interface between the inspection service server 402 and the user-related client device 404. The API can also provide an interface to the inspection client device 403. The inspection client device 403 can be used by a professional inspector to validate or update inspection data, e.g., in the scheme described with reference to FIG. 1. The inspection client device 403 can be used internally to the property inspection company to validate the user submitted entries into the form. The inspection client device 403 can be used to review the information in the database related to a construction project. The inspection client device 403 can also be used to prepare a report package using the inspection data for submission to the requesting third party.

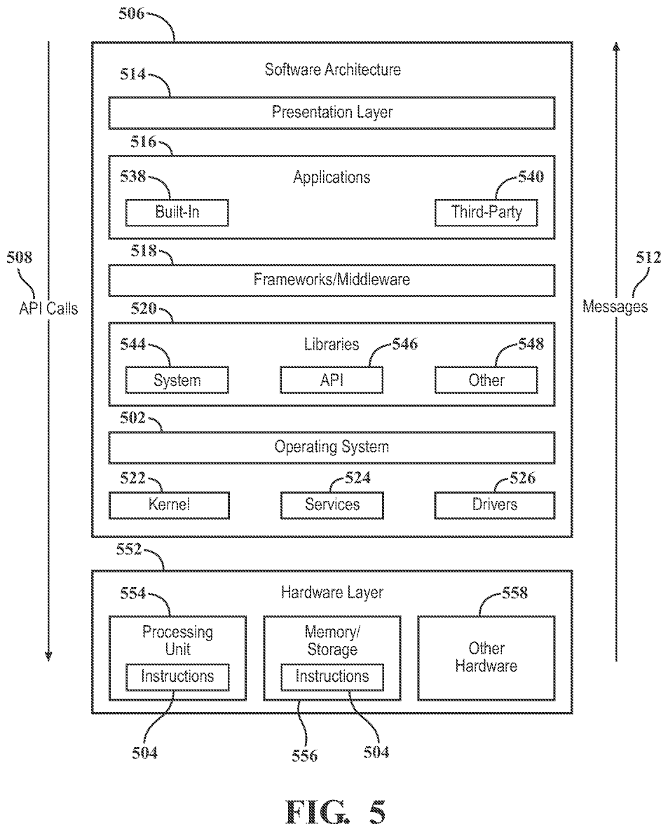

FIG. 5 is a block diagram illustrating an exemplary software architecture 506, which may be used in conjunction with various hardware architectures herein described. FIG. 5 is a non-limiting example of a software architecture and it will be appreciated that many other architectures may be implemented to facilitate the functionality described herein, for example to execute receiving and verifying images related to construction or repair. The software architecture 506 may execute on hardware such as machine 600 of FIG. 6 that includes, among other things, processors 604, memory 614, and I/O components 618. A representative hardware layer 552 is illustrated and can represent, for example, the machine 600 of FIG. 6. The representative hardware layer 552 includes a processing unit 554 having associated executable instructions 504. Executable instructions 504 represent the executable instructions of the software architecture 506, including implementation of the methods, components and so forth described herein. The hardware layer 552 also includes memory or storage modules memory/storage 556, which also have executable instructions 504. The hardware layer 552 may also comprise other hardware 558.

As used herein, the term “component” may refer to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions.

Components may constitute either software components (e.g., code embodied on a machine-readable medium) or hardware components. A “hardware component” is a tangible unit capable of performing certain operations and may be configured or arranged in a certain physical manner. In various exemplary embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations.

A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a processor or other programmable processor. Once configured by such software, hardware components become specific machines (or specific components of a machine) uniquely tailored to perform the configured functions and are no longer processors. It will be appreciated that the decision to implement a hardware component mechanically, in dedicated and permanently configured circuitry, or in temporarily configured circuitry (e.g., configured by software) may be driven by cost and time considerations.

A processor may be, or in include, any circuit, circuitry, or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously. The processor as used herein may be a hardware component, which is in at least one of the devices, systems, servers and the like. The processor may include multiple cores and may be spread across multiple devices. The processor includes circuitry to execute instructions relating to the methods and structures described herein for determining relationships and outputting relationship data that is used by various device and their users.

Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a processor configured by software to become a special-purpose processor, the processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access.

For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components.

Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some exemplary embodiments, the processors or processor-implemented components may be located in a single geographic location (e.g., within a home environment, an office environment, or a server farm). In other exemplary embodiments, the processors or processor-implemented components may be distributed across a number of geographic locations.

In the exemplary architecture of FIG. 5, the software architecture 506 may be conceptualized as a stack of layers where each layer provides particular functionality. For example, the software architecture 506 may include layers such as an operating system 502, libraries 520, applications 516 and a presentation layer 514. Operationally, the applications 516 or other components within the layers may invoke application programming interface (API) API calls 508 through the software stack and receive messages 512 in response to the API calls 508. The layers illustrated are representative in nature and not all software architectures have all layers. For example, some mobile or special purpose operating systems may not provide a frameworks/middleware 518, while others may provide such a layer. Other software architectures may include additional or different layers.

The operating system 502 may manage hardware resources and provide common services. The operating system 502 may include, for example, a kernel 522, services 524 and drivers 526. The kernel 522 may act as an abstraction layer between the hardware and the other software layers. For example, the kernel 522 may be responsible for memory management, processor management (e.g., scheduling), component management, networking, security settings, and so on. The services 524 may provide other common services for the other software layers. The drivers 526 are responsible for controlling or interfacing with the underlying hardware. For instance, the drivers 526 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 520 provide a common infrastructure that is used by the applications 516 or other components or layers. The libraries 520 provide functionality that allows other software components to perform tasks in an easier fashion than to interface directly with the underlying operating system 502 functionality (e.g., kernel 522, services 524 or drivers 526). The libraries 520 may include system libraries 544 (e.g., C standard library) that may provide functions such as memory allocation functions, string manipulation functions, mathematical functions, and the like. In addition, the libraries 520 may include API libraries 546 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 520 may also include a wide variety of other libraries 548 to provide many other APIs to the applications 516 and other software components/modules.

The frameworks/middleware 518 (also sometimes referred to as middleware) provide a higher-level common infrastructure that may be used by the applications 516 or other software components/modules. For example, the frameworks/middleware 518 may provide various graphic user interface (GUI) functions, high-level resource management, high-level location services, and so forth. The frameworks/middleware 518 may provide a broad spectrum of other APIs that may be utilized by the applications 516 or other software components/modules, some of which may be specific to a particular operating system 502 or platform.

The applications 516 include built-in applications 538 or third-party applications 540. The third-party applications 540 may invoke the API calls 508 provided by the operating system 502 to facilitate functionality described herein.

The applications 516 may use built in operating system functions (e.g., kernel 522, services 524 or drivers 526), libraries 520, and frameworks/middleware 518 to create user interfaces to interact with users of the system. Alternatively, or additionally, in some systems interactions with a user may occur through a presentation layer, such as presentation layer 514. In these systems, the application/component “logic” can be separated from the aspects of the application/component that interact with a user.

FIG. 6 is a block diagram illustrating components (also referred to herein as “modules”) of a machine 600, according to some exemplary embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 610 (e.g., software, a program, an application, an applet, an app, or other executable code) for causing the machine 600 to perform any one or more of the methodologies discussed herein may be executed. As such, the instructions 610 may be used to implement modules or components described herein. The instructions 610 transform the non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a laptop computer, a network router, a network switch, a network bridge, or any machine capable of executing the instructions 610, sequentially or otherwise, that specify actions to be taken by machine 600. Further, while only a single machine 600 is illustrated, the term “machine” shall also be taken to include a collection of machines that individually or jointly execute the instructions 610 to perform any one or more of the methodologies discussed herein.

The machine 600 may include processors 604, memory memory/storage 606, and I/O components 618, which may be configured to communicate with each other such as via a bus 602. The memory/storage 606 may include a memory 614, such as a main memory, or other memory storage, and a storage unit 616, both accessible to the processors 604 such as via the bus 602. The storage unit 616 and memory 614 store the instructions 610 embodying any one or more of the methodologies or functions described herein. The instructions 610 may also reside, completely or partially, within the memory 614, within the storage unit 616, within at least one of the processors 604 (e.g., within the processor's cache memory), or any suitable combination thereof, during execution thereof by the machine 600. Accordingly, the memory 614, the storage unit 616, and the memory of processors 604 are examples of machine-readable media.

As used herein, the term “machine-readable medium,” “computer-readable medium,” or the like may refer to any component, device or other tangible media able to store instructions and data temporarily or permanently. Examples of such media may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions. The term “machine-readable medium” may also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” may refer to a single storage apparatus or device, as well as “cloud-based” storage systems or storage networks that include multiple storage apparatus or devices. The term “machine-readable medium” excludes signals per se.

The I/O components 618 may include a wide variety of components to provide a user interface for receiving input, providing output, producing output, transmitting information, exchanging information, capturing measurements, and so on. The specific I/O components 618 that are included in the user interface of a particular machine 600 will depend on the type of machine. It will be appreciated that the I/O components 618 may include many other components that are not shown in FIG. 6. The I/O components 618 are grouped according to functionality merely for simplifying the following discussion and the grouping is in no way limiting. In various exemplary embodiments, the I/O components 618 may include output components 626 and input components 628. The output components 626 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 628 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like. The input components 628 may also include one or more image-capturing devices, such as a digital camera for generating digital images or video. The digital images can be used to verify the progress of the work at the location. In an example embodiment, the device 600 can provide the location coordinates with the images.

In further exemplary embodiments, the I/O components 618 may include biometric components 630, motion components 634, environmental environment components 636, or position components 638, as well as a wide array of other components. One or more of such components (or portions thereof) may collectively be referred to herein as a “sensor component” or “sensor” for collecting various data related to the machine 600, the environment of the machine 600, a user of the machine 600, or a combination thereof.

Communication may be implemented using a wide variety of technologies. The I/O components 618 may include communication components 640 operable to couple the machine 600 to a network 632 or devices 620 via coupling 622 and coupling 624 respectively. For example, the communication components 640 may include a network interface component or other suitable device to interface with the network 632. In further examples, communication components 640 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 620 may be another machine or any of a wide variety of peripheral devices (e.g., a peripheral device coupled via a Universal Serial Bus (USB)). Moreover, the communication components 640 may detect identifiers or include components operable to detect identifiers.

As described herein, the present disclosure, the methods include the insurance loss draft order request will be automatically generated (consumed) via our proprietary application programming interface (API), processed and made available to the home owner (end user) via an electronic device. Analysis, authentication and property validation is performed prior to allowing the end user to proceed for review, approve or reject the scope of repair via a graphical user interface form, e.g., a computer generated form. The form includes position and location information, e.g., latitude and longitude category in the form, and scope information, e.g., a scope category in the form.

The end user, through a user device, can document the quantity of work completed, e.g., percentage of work completed with a score of 0 to 100 or various milestones of completion, which depend on the project. Scores less than 100 can trigger further analysis and documentation by the end user, through the device. The end user may also be required to provide photo and supporting documentation to fulfill the scope of work performed by scope category.

Furthermore, the information input to the device and system by the end user device may be required to provide an electronic signature and affidavit that the information submitted is valid. The system may also require confirmation that this information is submitted under their own free will.

Methods and systems can transmit the form and the submitted information via an application programming interface (API) for acquiring the needed information and approval of the information or scope of work completed. Methods and systems will provide (expose) results provided by the end user via our proprietary application programming interface (API).

The present systems and methods can also be used to provide a virtual third party inspection of a work site. The work site can be a construction or repair site. The user-related device or device 600 can be used to provide a live video image to an inspection professional who is remote from the work site. The remote inspection professional can use an API to screen shot the images being shown. This can be performed for the user's who may not be able to correctly upload the proper images using the methods and systems described herein.

Obviously, many modifications and variations of the present invention are possible in light of the above teachings an may be practiced otherwise than as specifically described while within the scope of the appended invention. It is that all features descried and of all embodiments can be combined with each other, so long as such combination would not contradict one another.

It is intended that the foregoing detailed description be understood as an illustration of selected forms that the invention can take and not as a definition of the invention. It is only the following claims, including all equivalents that are intended to define the scope of the claimed invention. Finally, it should be noted that any aspect of any of the preferred embodiments described herein can be used alone or in combination with one another.

What is claimed is:

1. A method comprising:
receiving an electronic form including an image and work progress data; wherein the validation data includes location coordinates and at least one of: device identification, end user signature, requested data relating to status of work progress, work completion indication, or combinations thereof;
comparing the location coordinates to stored property location to verify the image and work progress data in the form;
with the location coordinates matching stored location coordinates, approving the image at the location of interest; and
with the location coordinates not matching the stored location coordinates, requesting a user to upload new images.

2. The method of claim 1, wherein receiving the electronic form includes providing a first graphical user interface for a first requested data, a second graphical user interface for second requested data, and additional graphical user interfaces for any additional requested data.

3. The method of claim 1, wherein comparing the location coordinates includes setting a geofence around given coordinates related to a structure at a real estate location and with the location coordinates being within the geofence, approving the image at the location of interest and with the location coordinates being outside the geofence, requesting a user to upload new images.

4. The method of claim 1, wherein comparing includes imprinting the location coordinates in the image with the location coordinates matching stored location coordinates.

5. The method of claim 1, further comprising enrolling a user device with an inspection service server sending an electronic request to the user device with a secure link and the user device providing location coordinates to the inspection service server to be stored as the location coordinates at which work to be inspected is located.

6. The method of claim 5, wherein enrolling includes requesting an image of the exterior of the work site that includes the address in the image.

7. The method of claim 1, further comprising receiving a request to update work at the location, wherein the request includes a work type, generating the electronic form using the category of work type, and providing a form access code to the user device.

8. The method of claim 7, wherein generating the electronic form includes generating a plurality of graphical user interfaces that require a user device to sequentially enter requested work progress data into the electronic form.

9. The method of claim 8, wherein generating the electronic form includes a first graphical user interface at the user device requesting user identification, a second graphical user interface at the user device requesting user identification requesting images of a work site, and a third graphical user interface at the user device requesting a user affidavit that the information submitted in the electronic form is accurate.

10. The method of claim 7, wherein generating the electronic form includes providing the user device with preselected classifications for the categories.

11. A loss draft system, comprising:
an inspection server to generate an electronic inspection form that requests image and work progress data; wherein the validation data includes location coordinates and at least one of: device identification, end user signature, requested data relating to status of work progress, work completion indication, or combinations thereof, the inspection server stores location coordinates of the work site; and
a user device in remote communication with the inspection server and configured to engage the electronic form to provide images and location coordinates;
wherein the inspection server comparing the location coordinates from the user device with the stored work site coordinates to verify the image and work progress data in the electronic form, with the location coordinates matching stored work site coordinates, approving the image as being of the work site, and with the location coordinates not matching the stored work site coordinates, the inspection server requests a new image from the user device.

11. The system of claim 10, wherein the user device include a GPS module to provide GPS coordinates to the inspection server through the electronic form when an image is uploaded.

12. The system of claim 10, wherein the inspection server is configured to set a geofence around the work site to allow a variance of location coordinates uploaded from the user device relative to the stored work site coordinates.

13. The system of claim 10, wherein the inspection server is configured to receive a request to update work at the work site from a third party device, wherein the request includes a work type, and the inspection server generates the electronic form using the category of work type and provides a form access code to the user device.

14. The system of claim 13, wherein the inspection server communicates a proof package including the image from the work site with location coordinates to the third party device.

15. The system of claim 13, wherein the inspection server assigns a category of work based on the request and generates the electronic inspection form based on the category to have certain required images and defines data entry fields in the graphical user interface to be displayed on the user device.
